(19) United States
(12) Patent Application Publication
(10) Pub. No.: US 2024/0112657 A1
(43) Pub. Date: Apr. 4, 2024

(54) KEY WEIGHT AND KEY FOR KEYBOARD INSTRUMENT

(71) Applicant: KABUSHIKI KAISHA KAWAI GAKKI SEISAKUSHO, Hamamatsu-shi (JP)

(72) Inventor: Takuma MURAI, Hamamatsu-shi (JP)

(21) Appl. No.: 18/473,937

(22) Filed: Sep. 25, 2023

(30) Foreign Application Priority Data
Sep. 30, 2022 (JP) 2022-157248

(51) Int. Cl. G10H 1/34

(52) U.S. Cl. CPC G10H 1/346; G10H 2220/221; G10H 2220/265

(57) ABSTRACT

A key weight capable of being easily mounted in a key for a keyboard instrument and being positively prevented from falling off the key. The key weight is mounted in the key by being inserted from outside into a weight-accommodating portion of the key, and includes a block-shaped weight body portion, protrusions that are formed on an insertion leading end of the weight body portion into the weight-accommodating portion and are elastically deformed by a reaction force from a far-side wall surface of the weight-accommodating portion when the weight body portion in a state in contact with the far-side wall surface during mounting of the key weight is pushed into the weight-accommodating portion, and latched portions that are formed on side surfaces of the weight body portion and are latched with side walls of the weight-accommodating portion.

### BACKGROUND OF THE INVENTION

### Field of the Invention

The present invention relates to a key weight which is applied to a keyboard device for a keyboard instrument, such as an electronic piano, and is mounted in a key so as to obtain a desired touch weight to be given during key depression, and a key for the keyboard instrument in which the key weight is mounted.

### Description of the Related Art

Conventionally, as a key weight and a key for a keyboard instrument of the above-mentioned type, there have been known, for example, ones disclosed in Japanese Laid-Open Patent Publication (Kokai) No. 2015-114597 already filed by the present applicant. This key weight is formed of rubber mixed with iron powder, and includes a weight body having a rectangular parallelepiped shape, and ridge portions which are formed on opposite left and right side surfaces of the weight body and each include a plurality of ridges arranged side by side in a vertical direction. On the other hand, the key is a white key extending in a front-rear direction, and has a front end thereof formed with a weight accommodating portion (weight mounting space in Japanese Laid-Open Patent Publication (Kokai) No. 2015-114597) which is open downward.

During manufacturing of the key, when the above-described key weight is mounted in the key, the key weight is pushed into the weight accommodating portion from below the key. With this, the left and right ridge portions of the key weight are elastically deformed while being sandwiched between the weight body and the left and right side walls of the weight accommodating portion, and by thrust due to returning forces of the elastically deformed ridge portions, the key weight is fixed to the front end of the key. Thus, the key weight, described above, is configured to be capable of being easily mounted in the key only by being pushed into the weight accommodating portion of the key.

However, since the above-described key weight mounted in the key is fixed to the weight accommodating portion of the key only by the thrust of the left and right ridge portions, if the returning forces due to the elastic deformation of the ridge portions are reduced, there is a fear that the key weight is displaced downward or falls off the key. Of course, e.g. by forming protrusions slightly protruding inward on wall surfaces of the weight accommodating portion of the key, it is possible to latch the ridge portions of the key weight with the protrusions from below and prevent the key weight from falling off the key.

When the above-mentioned latching protrusions are formed on the wall surfaces of the weight accommodating portion, to mount the key weight in the key, it is necessary to push the key weight into the weight accommodating portion of the key such that all ridges of the ridge portions of the key weight get over the protrusions. However, to mount the key weight in the key, a very large force is sometimes required depending on the positional relationship between the protrusions of the key and the ridge portions of the key weight, the shape, size and elastic characteristics of the key weight. For example, in a case where the ridge portions have not gotten over the protrusions in a state in which a flat upper surface of the key weight pushed into the weight accommodating portion is in contact with a top wall of the weight accommodating portion, the key weight is required to be further pushed into the weight accommodating portion, but since the whole upper surface of the key weight is in contact with the top wall of the weight accommodating portion, a reaction force produced when pushing the key weight is increased. As a result, a very large force is required to push the key weight, which sometimes increases time and labor for mounting the key weight in the key.

### SUMMARY OF THE INVENTION

It is a first object of the present invention to provide a key weight which can be easily mounted in a key and be positively prevented from falling off the key.

It is a second object of the present invention to provide a key for a keyboard instrument, to which the key weight is stably fixed.

To attain the above first object, in a first aspect of the present invention, there is provided a key weight that is made of an elastic material and is mounted in a key for a keyboard instrument by being inserted from outside into a weight-accommodating portion formed in the key, including a weight body portion that is formed into a block shape, an elastically deformed portion that is formed on an insertion leading end of the weight body portion into the weight-accommodating portion, and is elastically deformed by a reaction force from a far-side wall surface of the weight-accommodating portion when the weight body portion in a state in contact with the far-side wall surface during mounting of the key weight is pushed into the weight-accommodating portion, and a latched portion that is formed on a side surface of the weight body portion and is latched with a side wall of the weight-accommodating portion.

According to this construction, when the key weight is mounted in the key, the key weight is inserted into the weight-accommodating portion of the key. In this case, first, the elastically deformed portion of the key weight is brought into contact with the far-side wall surface of the weight-accommodating portion of the key. In this state, when the weight body portion of the key weight is pushed into the weight-accommodating portion, the elastically deformed portion is elastically deformed by the reaction force from the wall surface of the weight-accommodating portion. As a result, the whole key weight is accommodated in the weight-accommodating portion, and the latched portion of the key weight is latched with the side wall of the weight-accommodating portion. As described above, during mounting of the key weight in the key, even when the key weight is brought into contact with the far-side wall surface of the weight-accommodating portion, it is possible to easily mount the key weight in the key by pushing the weight body portion into the weight accommodating portion with a relatively small force, and it is possible to positively prevent the key weight from falling off the key by latching the latched portion of the key weight with the side wall of the weight-accommodating portion.

Preferably, the elastically deformed portion is formed by one or two or more protrusions protruding upward from an upper surface of the weight body portion.

According to the construction of this preferred embodiment, the elastically deformed portion can be formed relatively easily by the one or two or more protrusions protruding upward from the upper surface of the weight body portion.

More preferably, each protrusion has an M shape in front view.

According to the construction of this preferred embodiment, by employing the one or each of the protrusions having the M shape in front view, e.g. a pair of M-shaped protrusions can be elastically deformed such that the protrusions are bent to increase a distance therebetween. With this, even if the protrusions are made of a relatively hard elastic material, it is possible to secure elastic deformation of the protrusion(s) when the key weight is mounted in the key.

Preferably, the elastically deformed portion includes a flat portion having an upper surface formed flat, and a cavity portion formed below the flat portion such that the cavity portion horizontally extends through the key weight.

According to the construction of this preferred embodiment, since the cavity portion horizontally extending through the key weight is formed below the flat portion, compared with a case in which no cavity portion is provided, it is possible to more easily elastically deform the vicinity of the cavity portion in a vertical direction. Thus, simply by forming the cavity portion below the flat portion, it is possible to easily obtain a desired elastically deformed portion of the key weight.

To attain the above second object, in a second aspect of the present invention, there is provided a key for a keyboard instrument, in which the key weight described above is mounted, wherein the key includes the weight-accommodating portion having a hollow shape open downward, and wherein the side wall of the weight-accommodating portion is formed with the latching portion which latches the latched portion of the key weight by supporting the latched portion from below in a state in which the key weight is accommodated in the weight-accommodating portion.

According to this construction, the weight-accommodating portion formed in the key has the hollow shape open downward. The latching protrusion formed on the side wall of the weight-accommodating portion latches the latched portion of the key weight accommodated in the weight-accommodating portion by supporting the latched portion from below. With this, it is possible to easily obtain the key in which the key weight is securely mounted in the state accommodated in the weight-accommodating portion.

Preferably, the latching protrusion is provided such that during mounting of the key weight in the weight-accommodating portion, when the elastically deformed portion of the key weight is brought into contact with the far-side wall surface of the weight-accommodating portion, the latching protrusion is located upward of the latched portion, whereas when the elastically deformed portion is deformed due to pushing of the key weight into the weight-accommodating portion, the latching protrusion is located downward of the latched portion.

According to the construction of this preferred embodiment, the latching protrusion is provided at the above-described predetermined location, whereby during mounting the key weight in the weight-accommodating portion, after the elastically deformed portion of the key weight is brought into contact with the far-side wall surface of the weight-accommodating portion, the key weight is further pushed into the weight-accommodating portion, whereby the latched portion of the key weight gets over the latching protrusion and is located upward of the latching protrusion. As a result, the latching protrusion is located downward of the latched portion of the key weight, whereby the key weight can be stably latched from below.

The above and other objects, features, and advantages of the present invention will become more apparent from the following detailed description taken in conjunction with the accompanying drawings.

### BRIEF DESCRIPTION OF THE DRAWINGS

FIGS. 1A to 1D are views of a key weight and a key for a keyboard instrument according to an embodiment of the present invention, in which FIG. 1A is an appearance perspective view of the key, FIG. 1B is a side view of the key, FIG. 1C is a cross-sectional view taken along line c-c of FIG. 1B, and FIG. 1D is a cross-sectional view taken along line d-d of FIG. 1C;

FIGS. 2A and 2B are views of the key weight, in which FIG. 2A is a front view, and FIG. 2B is an appearance perspective view;

FIG. 3 is a view corresponding to FIG. 1C, which is useful in explaining respective sizes of a weight accommodating portion of a key body and the key weight;

FIGS. 4A to 4C are views sequentially showing procedure steps of mounting the key weight in the key body, in which FIG. 4A shows a state before the key weight is inserted into the weight accommodating portion, FIG. 4B shows a state in which protrusions of the key weight are in contact with a top wall of the key, and FIG. 4C shows a state in which the key weight is accommodated in the weight accommodating portion; and

FIGS. 5A to 5C are views of variations of the key weight, in which FIG. 5A shows a first variation including a single protrusion, FIG. 5B shows a second variation including three protrusions, and FIG. 5C shows a third variation including three cavity portions below a flat portion.

### DETAILED DESCRIPTION OF PREFERRED EMBODIMENTS

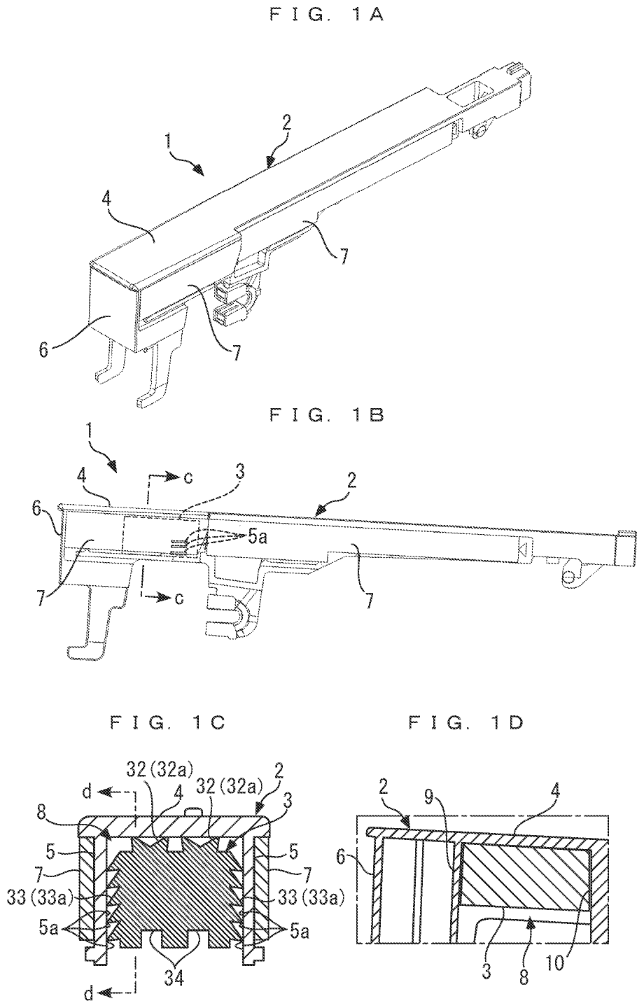

The present invention will now be described in detail with reference to the drawings showing a preferred embodiment thereof. FIGS. 1A to 1D show a key in which a key weight according to an embodiment of the present invention is mounted. As shown in FIGS. 1A to 1D, the key 1 is a white key used in a keyboard device for a keyboard instrument, such as an electronic piano, which is formed by arranging a multiplicity of (e.g. 88) keys 1, together with black keys, not shown, in parallel in a left-right direction. The key 1 includes a key body 2 extending in a front-rear direction (left-right direction in FIG. 1B) and the key weight 3 mounted in the key body 2.

The key body 2 is made of a predetermined kind of synthetic resin (e.g. an AS resin) and is formed as a molded article having a predetermined shape extending in the front-rear direction. Specifically, the key body 2 includes a horizontal top wall (far-side wall) 4, left and right side walls 5 and 5 (see FIG. 1C) vertically extending downward from opposite left and right ends of the top wall 4, respectively, and a front wall 6 provided on front ends of the top wall 4 and the left and right side walls 5 and 5. Note that a reference numeral 7 indicates woody boards, which are attached to outer peripheral surfaces of the left and right side walls 5 and 5 e.g. by bonding.

Further, as shown in FIGS. 1B to 1D, the key body 2 has a weight accommodating portion 8 in a front end thereof so as to mount the key weight 3 in the key body 2 in a state accommodated in the weight accommodating portion 8. The weight accommodating portion 8 has a box shape open downward. Specifically, the weight-accommodating portion 8 having a predetermined size is defined by the top wall 4, the left and right side walls 5 and 5, a rib wall 9 provided at a predetermined location rearward of the front wall 6, and a rear wall 10 provided at a predetermined location rearward of the rib wall 9.

Further, three latching protrusions 5a for latching the key weight 3 are formed to protrude from each of inner surfaces of the left and right side walls 5 and 5, with a spacing therebetween in a vertical direction. Each latching protrusion 5a extends a predetermined length in the front-rear direction and is formed into a tapered shape protruding inward. Further, out of the three latching protrusions 5a formed on each side wall 5, a lowermost latching protrusion 5a is larger and protrudes further inward than the other two latching protrusions 5a.

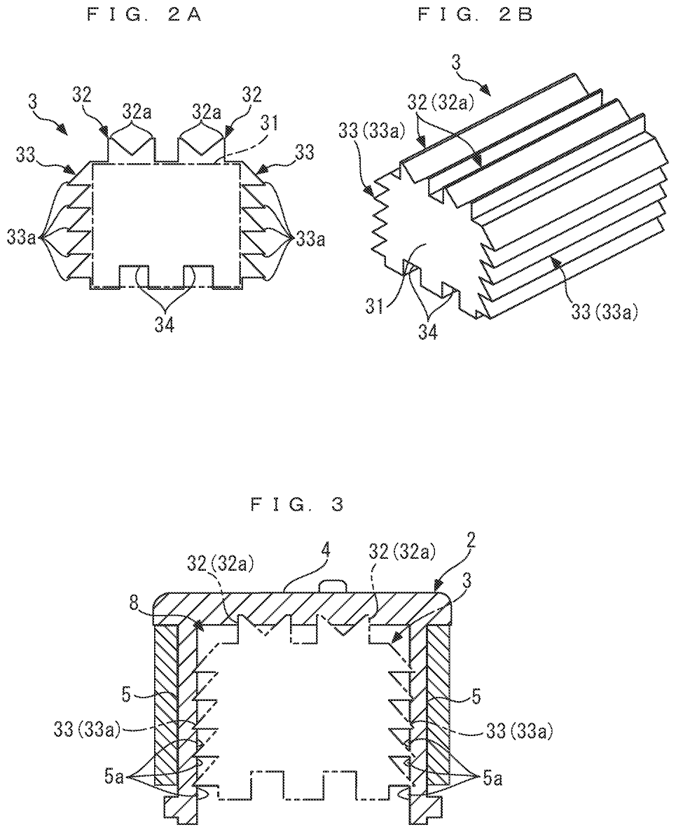

FIGS. 2A and 2B show the key weight 3. FIG. 2B is a front view and FIG. 2B is an appearance perspective view. The key weight 3 is made of e.g. a predetermined kind of rubber having a relatively large specific gravity or rubber mixed with metal powder such as iron powder. Further, the key weight 3 is comprised of a weight body portion 31 formed into a block shape, protrusions 32 (elastically deformed portions) protruding upward from an upper surface of the weight body portion 31, and latched portions 33 that protrude outward from each of opposite left and right side surfaces of the weight body portion 31 and are latched with the side walls 5 and 5 of the weight-accommodating portion 8.

The weight body portion 31 has an approximately rectangular parallelepiped shape. The protrusions 32 are formed by two protrusions 32 and 32 that are each formed into an M shape in front view and are arranged with a predetermined spacing therebetween in the left-right direction. Further, each protrusion 32 includes upper ridges 32a and 32a symmetrically formed and extends along the entire upper surface of the weight body portion 31 in the front-rear direction (in a depth direction in FIG. 2A).

Each latched portion 33 has a sawtooth shape in front view, as a whole, and is formed by five lateral ridges 33a arranged side by side along the vertical direction. Each lateral ridge 33a has a sloped surface and a horizontal surface as upper and lower surfaces and extends along the entity of an associated one of the side surfaces of the weight body portion 31 in the front-rear direction.

Further, the weight body portion 31 has a lower end formed with two recesses 34 open downward with a predetermined spacing therebetween in the left-right direction. Each recess 34 extends along the entire lower surface of the weight body portion 31 in the front-rear direction. These recesses 34 make the lower end of the weight body portion 31 easy to elastically deform inward in the left-right direction.

FIG. 3 corresponds to FIG. 1C, and the key weight 3 before being accommodated in the weight-accommodating portion 8 is indicated by two-dot chain lines. As shown in FIG. 3 and FIGS. 2A and 2B, in the key weight 3, the weight body portion 31 is formed to be smaller than the weight-accommodating portion 8, and an outer shape of the whole key weight 3 including the protrusions 32 on the top of the weight body portion 31 and the latched portions 33 is formed to be slightly larger than the weight-accommodating portion 8.

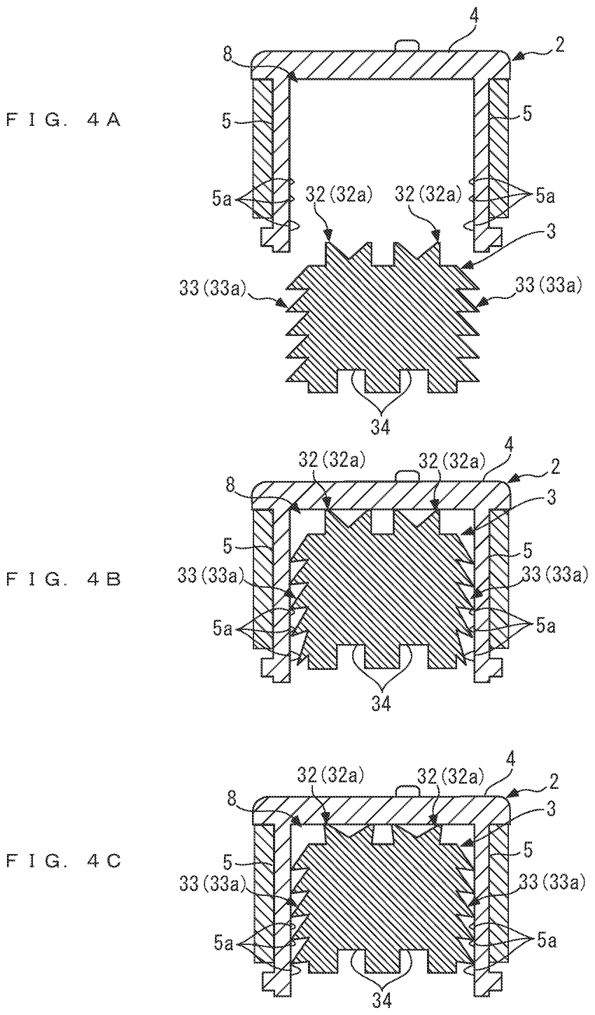

FIGS. 4A to 4C sequentially show procedure steps of mounting the key weight 3 in the key body 2. FIG. 4A shows a state before the key weight 3 is inserted into the weight accommodating portion 8. The key weight 3 is inserted into the weight accommodating portion 8 from below the key body 2. During this insertion, each lateral ridge 33a of the left and right latched portions 33 of the key weight 3 receive a reaction force from an associated one of the side walls 5 of the weight-accommodating portion 8 and is elastically deformed such that the lateral ridge 33a is bent below.

FIG. 4B shows a state immediately after respective upper ends of the protrusions 32 formed on an upper end portion of the key weight 3 accommodated in the weight accommodating portion 8 are brought into contact with the top wall 4 of the key body 2. In this state, at the left and right latched portions 33 of the key weight 3, tip ends of the lowermost lateral ridges 33a are located downward of associated ones of the lowermost latching protrusions 5a of the side walls 5 of the weight accommodating portion 8. When the key weight 3 is further pushed into the weight accommodating portion 8 from this state, by a reaction force from a wall surface of the top wall 4, as shown in FIG. 4C, the upper ridges 32a and 32a of each protrusion 32 of the key weight 3 are elastically deformed such that they are bent in the left-right direction to increase a distance therebetween. Further, in this case, the left and right lowermost lateral ridges 33a and 33a of the key weight 3 get over the associated ones of the lowermost latching protrusions 5a and 5a of the weight accommodating portion 8 and are located upward of the lowermost latching protrusions 5a and 5a, whereby the lowermost lateral ridges 33a and 33a are latched with the associated lowermost latching protrusions 5a and 5a in a state supported from below by the lowermost latching protrusions 5a and 5a.

As described in detail heretofore, according to the key weight 3 of the present embodiment, during mounting the key weight 3 in the key body 2, even when the key weight 3 is brought into contact with the top wall 4 of the weight accommodating portion 8, it is possible, while elastically deforming the protrusions 32 of the upper end of the key weight 3, to push the key weight 3 into the weight accommodating portion 8 with a relatively small force, and it is possible to easily mount the key weight 3 in the key body 2. Further, when the key weight 3 is pushed into the weight accommodating portion 8, the lateral ridges 33a of the latched portions 33 and 33 on the opposite left and right sides of the key weight 3 are elastically deformed downward, and due to thrust by returning forces of the elastically deformed lateral ridge 33a, the key weight 3 is latched with the left and right side walls 5 and 5 of the weight-accommodating portion 8. In addition, the lower portions of the left and right latched portions 33 and 33 of the key weight 3 are latched with the latching protrusions 5a of the left and right side walls 5 and 5 of the weight-accommodating portion 8, in a state supported from below. Since the key weight 3 accommodated in the weight-accommodating portion 8 is latched as described above, it is possible to positively prevent the key weight 3 from falling off the key body 2.

Further, according to the key 1 of the present embodiment, it is possible to easily obtain the key 1 in which the above-described key weight 3 is securely mounted in the state accommodated in the weight-accommodating portion 8.

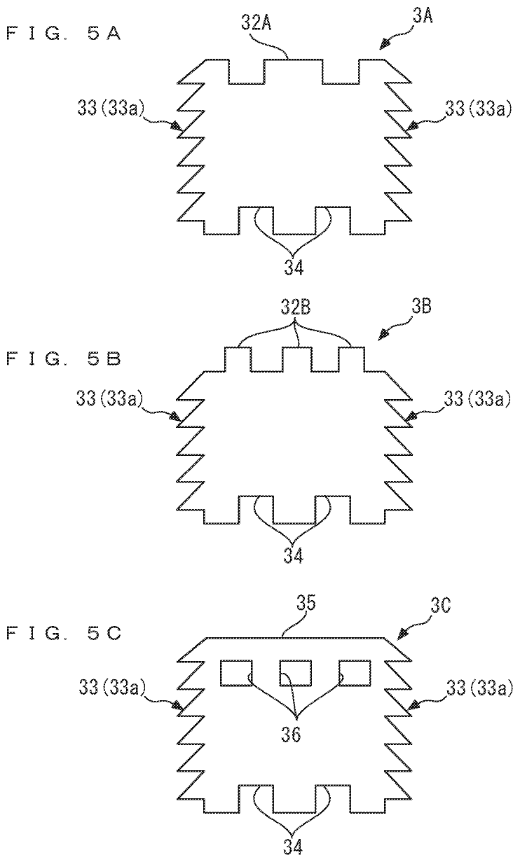

Note that the present invention is not limited to the above-described embodiment, but it can be practiced in various forms. FIGS. 5A to 5C are front views of variations of the key weight. A key weight 3A according to a first variation shown in FIG. 5A is different from the above-described key weight 3 in that in place of the two M-shaped protrusions 32, the key weight 3A has a single protrusion 32A having a rectangular shape in front view at a laterally central portion thereof and has six lateral ridges 33a and 33a on each of left and right sides thereof. Further, a key weight 3B according to a second variation shown in FIG. 5B is different from the above-described key weight 3 in that in place of the two M-shaped protrusions 32, the key weight 3B has three protrusions 32B each having a rectangular shape in front view with a predetermined spacing therebetween in the left-right direction.

Furthermore, a key weight 3C according to a third variation shown in FIG. 5C is different from the above-described key weight 3 in that in place of the two M-shaped protrusions 32, the key weight 3C includes a flat portion 35 having an upper surface formed flat and has three cavity portions 36 at predetermined locations below the flat portion 35. Each cavity portion 36 is formed such that it extends horizontally through the key weight 3C in the front-rear direction (in a depth direction in FIG. 5C). Thus, provision of the above-described cavity portions 36 below the flat portion 35, makes it possible, compared with provision of no cavity portions 36, to more easily elastically deform the vicinity of the cavity portions 36 in the vertical direction. The key weights 3A to 3C according to the first to third variations described above make it possible to obtain the same advantageous effects as provided by the key weight 3 described hereinabove.

Note that details of the constructions of the key weight 3 and the key weights 3A to 3C according to the variations shown in the embodiment are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

What is claimed is:

1. A key weight that is made of an elastic material and is mounted in a key for a keyboard instrument by being inserted from outside into a weight-accommodating portion formed in the key, comprising:
a weight body portion that is formed into a block shape;
an elastically deformed portion that is formed on an insertion leading end of the weight body portion into the weight-accommodating portion, and is elastically deformed by a reaction force from a far-side wall surface of the weight-accommodating portion when the weight body portion in a state in contact with the far-side wall surface during mounting of the key weight is pushed into the weight-accommodating portion; and
a latched portion that is formed on a side surface of the weight body portion and is latched with a side wall of the weight-accommodating portion.

2. The key weight according to claim 1, wherein the elastically deformed portion is formed by one or two or more protrusions protruding upward from an upper surface of the weight body portion.

3. The key weight according to claim 2, wherein each protrusion has an M shape in front view.

4. The key weight according to claim 1, wherein the elastically deformed portion includes:
a flat portion having an upper surface formed flat, and
a cavity portion formed below the flat portion such that the cavity portion horizontally extends through the key weight.

5. A key for a keyboard instrument, in which the key weight according to claim 1 is mounted,
wherein the key includes the weight-accommodating portion having a hollow shape open downward, and
wherein the side wall of the weight-accommodating portion is formed with the latching portion which latches the latched portion of the key weight by supporting the latched portion from below in a state in which the key weight is accommodated in the weight-accommodating portion.

6. The key according to claim 5, wherein the latching protrusion is provided such that during mounting of the key weight in the weight-accommodating portion, when the elastically deformed portion of the key weight is brought into contact with the far-side wall surface of the weight-accommodating portion, the latching protrusion is located upward of the latched portion, whereas when the elastically deformed portion is deformed due to pushing of the key weight into the weight-accommodating portion, the latching protrusion is located downward of the latched portion.
